(19) United States
(12) Patent Application Publication
(10) Pub. No.: US 2007/0087767 A1
(43) Pub. Date: Apr. 19, 2007

(54) Techniques to manage paging operations for idle mode mobile stations

(76) Inventors: Sameer Pareek, Portland, OR (US); Muthaiah Venkatachalam, Beaverton, OR (US)

Correspondence Address: KACVINSKY LLC;C/O INTELLEVATE, P.O. BOX 52050, MINNEAPOLIS, MN, 55402, US

(21) Appl. No.: 11/252,297

(22) Filed: Oct. 17, 2005

(51) Int. Cl. H04B 7/00

(52) U.S. Cl. 455/502; 455/518

(57) ABSTRACT

A paging controller to compute idle mode parameters associated with a first mobile station of at least one set of mobile stations located in a first paging group. The at least one set of mobile stations including the first mobile station and at least a second mobile station. The paging controller is to synchronize an upcoming mobile station paging listening interval for the at least one set of mobile stations.

### BACKGROUND

Communication systems exist today to enable electronic devices, e.g., computers, mobile devices, and/or personal communication devices, to communicate and exchange information such as voice and multimedia information (e.g., video, sound, data) over local and distributed networks. Wireless communication systems, enable wireless adapted electronic devices to communicate with each other and to communicate with other wireless electronics devices and computers connected to other local and distributed networks.

Wireless communication systems are being deployed pervasively in enterprise, residential, and public hotspots based on a variety of wireless standards. Wireless communication systems may employ multiple wireless technologies and wireless access standards. Modern wireless communication systems may operate according to Institute of Electrical and Electronics Engineers (IEEE) standards such as the 802.11 standards for Wireless Local Area Networks (WLANs) and the 802.16 standards for Wireless Metropolitan Area Networks (WMANs). Worldwide Interoperability for Microwave Access (WiMAX) is a wireless broadband technology based on the IEEE 802.16 standard of which IEEE 802.16-2004 and the 802.16e amendment are Physical (PHY) layer specifications.

In the context of mobile broadband wireless access (MBWA) systems, wireless communication systems may operate in accordance with protocols and standards that comply or communicate in accordance with the IEEE 802.16 series of protocols such as the WiMAX protocol, for example. The WiMAX standards-based wireless technology provides high-throughput broadband connections over long distances (long range). WiMAX can be used for a number of applications, including “last mile” wireless broadband connections, hotspots, cellular backhaul, and high-speed enterprise connectivity for business.

Future wireless communication systems that support the IEEE 802.16 based broadband wireless access technology may need to support and manage the operations of the wireless electronics devices throughout the wireless communication system known in the art as mobile stations. Management may include scheduling and synchronizing paging listening intervals for mobile stations. Also, management may include construction of paging broadcast messages for mobile stations while in idle mode. Accordingly, there is a need for apparatuses, systems, and methods to schedule and synchronize paging listening intervals for mobile stations and construct paging broadcast messages for mobile stations while in idle mode

### BRIEF DESCRIPTION OF THE DRAWINGS

FIG. 1 illustrates one embodiment of a system.

FIG. 2 illustrates one embodiment of paging cycle.

FIG. 3 illustrates one embodiment of a scheduling system.

FIG. 4 illustrates one embodiment of a flow diagram.

### DETAILED DESCRIPTION

The embodiments may generally relate to scheduling and synchronizing paging listening intervals for mobile stations distributed throughout MBWA systems that operate or communicate in accordance with various protocols and standards (e.g., that comply or communicate in accordance with the IEEE 802.16 series of protocols such as the WiMAX protocol). The embodiments also may generally relate to the construction of paging broadcast messages for the mobile stations while in idle mode. The embodiments are not limited in this context.

Efficient implementation of idle mode operation is a consideration in all mobile networks including future IEEE 802.16 based mobile WiMAX networks. At any given point in time, for example, a statistically larger percentage of mobile nodes in a network are not engaged in active calls (i.e., active mode) and thus are in idle mode. As a result, there may be a need within a given network to efficiently track a large population of mobile nodes while maintaining their power saving profile (i.e., not requiring the mobile nodes to resume active mode). Furthermore, there may be a need to efficiently track these mobile nodes while conserving valuable air-link resources in performing the tracking activity. Air-link messages such as MOB-PAG-ADV paging messages discussed in further detail herein generally do not comprise active user-traffic. Therefore, these types of air-link messages are non-revenue generating signaling overhead traffic for a network operator. Given a statistically large percentage of mobile nodes that may be in idle mode, reducing this signaling overhead may be valuable from a mobile network system design standpoint. Thus, the various embodiments described herein employ various techniques to reduce network signaling overhead.

Reducing network signaling overhead may be implemented in a variety of techniques. In one embodiment, idle mode listening intervals of multiple mobile stations may be synchronized using a paging controller rather than the base station where a mobile station first entered idle mode. A paging controller may be employed to perform the synchronization because it includes more information about a variety of network triggers within a paging group that can cause the idle mode mobile station to be paged. An example of a network trigger that may be employed is an incoming packet for an idle mode mobile station. A paging controller first receives such network triggers from data path functions residing in the access network. Hence, a paging controller may use this information for a large number of mobile stations to find opportunities to synchronize them into a single MOB-PAG-ADV paging message, as opposed to a base station. In one embodiment, a paging controller may be collocated within a base station, for example. Even in such cases where the paging controller is collocated within a base station, however, fewer base stations will have paging controllers (e.g., as described in IEEE-802.16) and other base stations may not have any paging controllers. Thus, the embodiments described herein provide improvements regardless of whether a paging controller resides within a base station or is located as a separate network entity.

In another embodiment, network signaling overhead reduction may be implemented by constructing a single MOB-PAG-ADV paging message for multiple mobile stations using only the information available at each individual base station, using several isolated triggers for generating a page (e.g., incoming packets for a mobile station) arriving at the base station from the paging controller. In accordance with the current implementation, and considering the above example of an incoming packet trigger for an idle mode mobile station, the paging controller will need to broadcast a trigger to all of its associated base stations in order to timely deliver the packet. This may employ a larger number of backbone messages between paging controllers and base stations.

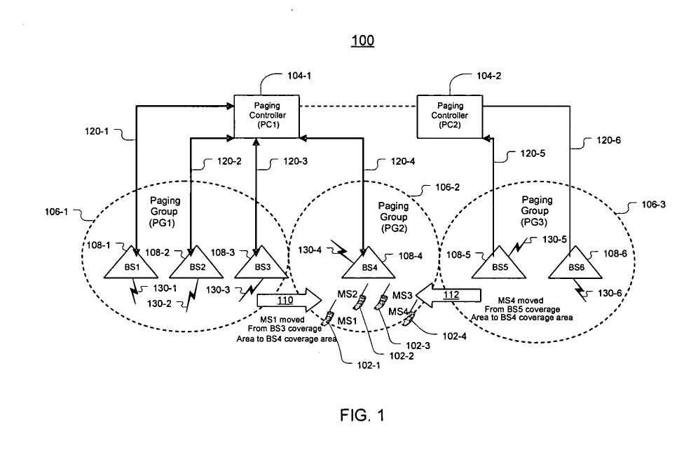

FIG. 1 illustrates one embodiment of a system. FIG. 1 illustrates a block diagram of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that additional or fewer nodes may be employed for a given implementation.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a mobile station (STA), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various implementations, the nodes of the communications system 100 may be arranged to segment a set of media information and control information into a series of packets. A packet generally may comprise a discrete data set having fixed or varying lengths, and may be represented in terms of bits or bytes. It can be appreciated that the described embodiments are applicable to any type of communication content or format, such as packets, cells, frames, fragments, units, and so forth.

The communications system 100 may communicate information in accordance with one or more standards, such as standards promulgated by the IEEE, the Internet Engineering Task Force (IETF), the International Telecommunications Union (ITU), and so forth. In various embodiments, for example, the communications system 100 may communicate information according to one or more IEEE 802 standards including IEEE 802.11 standards (e.g., 802.11a, b, g/h, j, n, and variants) for WLANs and/or 802.16 standards (e.g., 802.16a/d/e wireless broadband access systems, 802.16-2004, 802.16.2-2004, 802.16f, and variants) for WMANs. The communications system 100 may communicate information according to one or more of the Digital Video Broadcasting Terrestrial (DVB-T) broadcasting standard and the High performance radio Local Area Network (HiperLAN) standard. The embodiments are not limited in this context.

In various embodiments, the communications system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The communications system 100 may include one or more nodes arranged to communicate information over one or more wired and/or wireless communications media. Examples of wired communications media may include a wire, cable, printed circuit board (PCB), backplane, switch fabric, semiconductor material, twisted-pair wire, co-axial cable, fiber optics, and so forth. An example of a wireless communication media may include portions of a wireless spectrum, such as the radio-frequency (RF) spectrum. In such implementations, the nodes of the system 100 may include components and interfaces suitable for communicating information signals over the designated wireless spectrum, such as one or more transmitters, receivers, transceivers, amplifiers, filters, control logic, antennas and so forth.

The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth.

In various embodiments, the communications system 100 may comprise or form part of a network, such as a WiMAX network, a broadband wireless access (BWA) network, a WLAN, a WMAN, a wireless wide area network (WWAN), a wireless personal area network (WPAN), an SDMA network, a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, a Universal Mobile Telecommunications System (UTS) network, a High-Speed Downlink Packet Access (HSDPA) network, a Broadband Radio Access Networks (BRAN) network, a General Packet Radio Service (GPRS) network, a 3^{rd} Generation Partnership Project (3GPP) network, a local area network (LAN), a wide area network (WAN), a metropolitan area network (MAN), a Global Positioning System (GPS) network, an Ultra Wide Band (UWB) network, an Internet network, a World Wide Web network, a cellular network, a radio network, a satellite network, and/or any other communications network configured to carry data. The embodiments are not limited in this context.

The communications system 100 may employ various modulation techniques including, for example: OFDM modulation, Quadrature Amplitude Modulation (QAM), N-state QAM (N-QAM) such as 16-QAM (four bits per symbol), 32-QAM (five bits per symbol), 64-QAM (six bits per symbol), 128-QAM (seven bits per symbol), and 256-QAM (eight bits per symbol), Differential QAM (DQAM), Binary Phase Shift Keying (BPSK) modulation, Quadrature Phase Shift Keying (QPSK) modulation, Offset QPSK (OQPSK) modulation, Differential QPSK (DQPSK), Frequency Shift Keying (FSK) modulation, Minimum Shift Keying (MSK) modulation, Gaussian MSK (GMSK) modulation, and so forth. The embodiments are not limited in this context.

The communications system 100 may form part of a multi-carrier system such as a MIMO system. The MIMO system may employ one or more multi-carrier communications channels for communicating multi-carrier communication signals. A multi-carrier channel may comprise, for example, a wideband channel comprising multiple sub-channels. The MIMO system may be arranged to communicate one or more spatial data streams using multiple antennas. Examples of an antenna include an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the system 100 may comprise a physical (PHY) layer component for WLAN devices either hardware or software based on IEEE standards 802.11 n, 802.16-2004, and/or 802.16e, for example. In one embodiment, the communications system 100 may comprise a transceiver for a MIMO-OFDM system. The embodiments are not limited in this context.

As shown in FIG. 1, the communications system 100 may be illustrated and described as comprising several separate functional elements, such as modules and/or blocks. In various embodiments, the modules and/or blocks may be connected by one or more communications media. Communications media generally may comprise any medium capable of carrying information signals. For example, communication media may comprise wired communication media, wireless communication media, or a combination of both, as desired for a given implementation.

The modules and/or blocks may comprise, or be implemented as, one or more systems, sub-systems, processors, devices, machines, tools, components, circuits, registers, applications, programs, subroutines, or any combination thereof, as desired for a given set of design or performance constraints. Although certain modules and/or blocks may be described by way of example, it can be appreciated that a greater or lesser number of modules and/or blocks may be used and still fall within the scope of the embodiments. Further, although various embodiments may be described in terms of modules and/or blocks to facilitate description, such modules and/or blocks may be implemented by one or more hardware components (e.g., processors, DSPs, PLDs, ASICs, circuits, registers), software components (e.g., programs, subroutines, logic) and/or combination thereof.

System 100 may be implemented as a broadband wireless access network that operates in accordance with WiMAX wireless broadband technology based on the IEEE 802.16 standard, for example. System 100 may comprise multiple nodes such as mobile stations 102-1-m, paging controllers 104-1-n, paging groups 106-1-o, and base stations 108-1-p, where m, n, o, and p may represent any arbitrary number. Base stations 108-1-p and paging controllers 104-1-n may exchange various network backbone messages 120-1-p on various wired or wireless communication links. Each of the and mobile stations 102-1-m, paging controllers 104-1-n and/or base stations 108-1-p may comprise one or more processors, memories, and modules to implement the various functions described herein. The embodiments are not limited in this context.

For significant time durations T, mobile stations 102-1-m may be powered on in wireless network 100 but may not be in an active call session. To use time durations T as battery conserving opportunities, Idle Mode and Paging operations are described in the IEEE 802.16 standard. In accordance with these procedures, mobile stations 102-1-m enter a low-power state referred to as idle mode. The IEEE 802.16 standard specifies mechanisms to force mobile stations 102-1-m back into an active mode whenever required by network 100. This may occur, for example, when there is an incoming call for a mobile station 102-1-m. The IEEE 802.16 standard provides procedures to force mobile stations 102-1-m back into an active mode from an idle mode.

In one embodiment, a technique is described to keep paging controllers 104-1-n updated of a current paging group 106-1-o associated with a mobile station 102-1-m. A paging controller 104-1-n is a network 100 entity responsible for tracking activity related to mobile stations 102-1-m in idle mode. Paging controllers 104-1-n may be collocated in a base station 108-1-p or may be implemented as a separate network entity in access network 100. Paging groups 106-1-o may be identified by a paging group identification (PGID) and represent the coverage area of a cluster of base stations 108-1-p. As long as mobile stations 102-1-m in an idle mode remain in a paging group 106-1-o they do not have to update their location information (i.e., PGID) to paging controller 104-1-n. If mobile stations 102-1-m cross into different paging groups 106-1-o while in the idle mode, mobile stations 102-1-m perform a location update procedure to update paging controller 104-1-n of the new paging group(s) 106-1-o.

In another embodiment, a technique is described for paging controllers 104-1-n to track down and reach mobile stations 102-1-m in idle mode within the coverage area of their respective paging groups 106-1-o. This may be implemented using a broadcast message (mobile-paging-advertising or MOB-PAG-ADV). The broadcast message may be broadcast by all base stations 108-1-p in the respective paging groups 106-1-o whenever network 100 needs to reach any one of mobile stations 102-1-m. There may be a variety of reasons for network 100 to reach mobile stations 102-1-m. For example, to request an update of its location (i.e., paging group 106-1-o), perform network entry (e.g., when there is an incoming packet), among other reasons.

Various embodiments relate to managing the number of broadcast messages transmitted by base stations 108-1-p in any suitable manner. In one embodiment, the number of broadcast messages transmitted may be minimized without causing a large number of mobile stations 102-1-m to transition from an idle mode to a normal/active mode simultaneously. In one embodiment, the number of broadcast messages may be optimized to minimize the number of such broadcasts without causing a large number of mobile stations 102-1-m to transition from an idle mode to a normal/active mode simultaneously. The various techniques described herein may minimize ranging contention, timeouts, and potentially additional retransmissions of broadcast messages, for example. While in idle mode, mobile stations 102-1-m cycle through periods of availability and unavailability. During a period of availability, mobile stations 102-1-m are available or ready to receive transmissions from base stations 108-1-p. A period of availability may be referred to as a mobile station paging listening interval (PAGING_LISTENING_INTERVAL). During a period of unavailability, mobile stations are not available to receive such transmissions. The precise duration of the paging listening interval, the periodicity of occurrence of the duration (PAGING_CYCLE), and the precise frame numbers of when it occurs (calculated using PAGING_OFFSET) are determined between mobile stations 102-1-m and the network 108-1-p as part of the procedures to enter into idle mode.

Network 100 illustrates a representative network reference model in which the embodiments may be employed. Network 100 comprises three paging groups 106-1, 106-2, 106-3 and two paging controllers 104-1, 104-2, for example. Paging controller 104-1 manages paging groups 106-1 and 106-2. Paging controller 104-2 manages paging group 106-3. Paging group 106-1 comprises three base stations 108-1, 108-2, 108-3; paging group 106-2 comprises one base station 108-4; and paging group 106-3 comprises two base stations 108-5, 108-6. Base stations 108-1-4 and paging controller 104-1 exchange network backbone messages 120-1-4. Base stations 108-5-6 and paging controller 104-2 exchange network backbone messages 120-5-6. For brevity and illustrative purposes four mobile stations 102-1, 102-2, 102-3, 102-4 are shown. The embodiments are not limited in this context.

Each paging controller 104-1-2 maintains a location database that keeps information about all mobile stations 102-1-4 that have gone into idle mode in the particular paging group(s) 106-1-3 managed by the respective paging controller 104-1-2. FIG. 1 illustrates a snapshot in time T, of four representative mobile stations 102-1-4 in idle mode. At time T, all four mobile stations 102-1-4 are located in coverage area of base station 108-4 and in paging group 106-2, for example. Prior to T, mobile station 102-1 was in coverage area of base station 108-3 in paging group 106-1 and moved to base station 108-4 in paging group 106-2 as indicated by vector 110. Prior to T, mobile station 102-4 was in coverage area of base station 108-5 in paging group 106-3 and moved to base station 108-4 in paging group 106-2 as indicated by vector 112. Although only four idle mode mobile stations 102-1-4 are shown in FIG. 1, it will be expected that in actual deployments additional mobile stations, both idle mode and active mode, may be present in the coverage area of base station 108-4. The embodiments are not limited in this context.

The various embodiments provide techniques to schedule and synchronize listening intervals (PAGING_LISTENING_INTERVAL) of idle mode mobile stations 102-1-4 by broadcasting paging messages, such as the MOB-PAG-ADV broadcasts. Various embodiments of these techniques may provide a more efficient usage of MOB-PAG-ADV broadcast because the same paging message may be used to address multiple idle mode mobile stations 102-1-4 if or whenever required by synchronizing the respective listening intervals.

Accordingly, various embodiments of these techniques may be implemented in accordance with the following techniques for broadcasting paging messages in network 100. These techniques may include, for example, a procedure at network 100 provisioning time, a procedure when mobile stations 102-1-4 enter idle mode, and a procedure for constructing a MOB-PAG-ADV message for broadcasting. Because at time T all four mobile stations 102-1-4 are within coverage area of base station 108-4, the following embodiments are described with reference to base station 108-4 in paging group 106-2 and paging controller 104-1. The following description assumes that mobile station 102-1 has just entered the coverage area of base station 108-4 from the coverage area of base station 108-3 as indicated by vector 110. Accordingly, base station 102-1 will undergo an idle mode initiation procedure as described herein. The embodiments are not limited in this context.

Technique at Network Provisioning Time

At network 100 provisioning time, all paging controllers 104-1-2 in the access network 100 may be configured with the supported values of PAGING_CYCLE(s), for example. Depending on various factors, network 100 may support either a single value of PAGING_CYCLE throughout network 100 or multiple values of PAGING_CYCLE(s). For each PAGING_CYCLE, the respective paging controller 104-1 may be configured to support a fixed or variable number of evenly spaced PAGING_OFFSETs. The precise number of such paging offsets may vary based on and may depend upon specific deployment considerations. The embodiments are not limited in this context.

Technique When a Mobile Station Enters Idle Mode

To initiate idle mode, a mobile station 102-1 may transmit a de-registration request message (DREG-REQ) message to base station 108-4. Alternatively, base station 108-4 may transmit a de-registration command (DREG-CMD) message to mobile stations 102-1-4 in the coverage area. The idle mode initiation request message transmitted by mobile station 102-1 may be transmitted to paging controller 104-1 from base station 108-4. The idle mode initiation request message may be transmitted using a first network backbone message 120-4 between base station 108-4 and paging controller 104-1, for example. The network backbone message contains idle mode retain information for mobile station 102-1 requested to initiate idle mode. Paging controller 104-1 stores the idle mode retain information for mobile station 102-1 and transmits a second backbone message to base station 108-4 that includes values for PAGING_CYCLE, PAGING_OFFSET, and mobile station PAGING_LISTENING_INTERVAL value for mobile station 102-1. To construct the MOB-PAG-ADV message for all mobile stations 102-1-4 in idle mode, the embodiments provide techniques wherein paging controller 104-1 includes the functionality to determine various mobile station parameters such as, for example, PAGING_CYCLE, PAGING_OFFSET, and PAGING_LISTENING_INTERVAL for every mobile station 102-1-4 that is undergoing idle mode initiation within the respective coverage area. For example, in the illustrated embodiment, the functionality is part of paging controller 104-1 for every mobile station 102-1-4 undergoing idle mode initiation in the coverage area of base station 108-4 in paging group 106-2, for example.

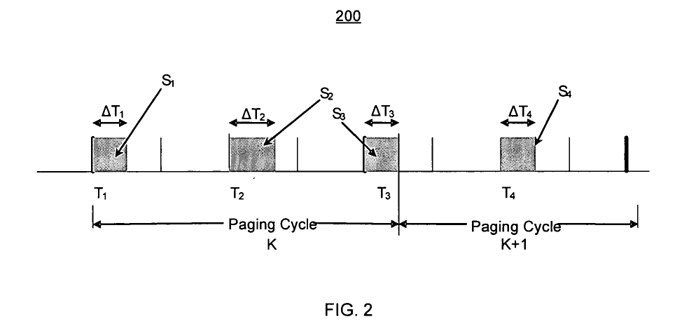

FIG. 2 illustrates one embodiment of a paging cycle. Paging cycle 200 illustrates the case when access network 100 supports one value of PAGING_CYCLE. As shown, four sets S1, S2, S3, and S4 of mobile stations located in one paging group, e.g., paging group 106-2, are calculated ahead for the next two PAGING_CYCLE times. Accordingly, mobile station 102-1 becomes part of a set of mobile stations that includes mobile stations 102-1-4, referred to as Sx. The set of mobile stations Sx is maintained by paging controller 104-1 for which the upcoming scheduling of mobile station PAGING_LISTENING_INTERVALS (identified by future time slots) either may be synchronized or may have overlapping time slots. A set Sx may comprise two or more (e.g., multiple) mobiles stations, for example. Paging controller 104-1 maintains such sets of mobile station 102-1-m identified by S1, S2, S3, . . . , SN. Each such set maybe characterized by a future time instant and duration [Tx, ΔTx] in milliseconds (ms). Tx is a future time instant from a starting reference time which is common to all base stations in a paging group (e.g., base station 108-4 in paging 106-2; or base stations 108-1-3 in paging group 106-1; or base stations 108-5-6 n paging group 106-3). ΔTx is a time duration starting from Tx. For example, reference common start time can be 0 ms, Tx can be 4500 ms, and ΔTx can be 20 ms corresponding to the duration of four MAC frames, wherein each frame is 5 ms, for example. The embodiments are not limited in this context.

In a general implementation of the embodiments, paging controller 104-1 may be adapted to compute idle mode parameters for all idle mode mobile stations 102-1-m within sets S1, S2, S3, . . . , SN, for example. The number of sets, N (wherein N≧1), and the number of idle mode mobile stations 102-1-m in each set S1, S2, S3, . . . , SN, are deployment considerations that may vary based on different requirements of network 100.

In one embodiment, paging controller 104-1 may be adapted to dynamically calculate or computes sets S1, S2, S3, . . . , SN ahead of time. The triggers for such calculation or computations may be periodic, aperiodic or a combination of both. Aperiodic triggers may occur, for example, when idle mode mobile stations 102-1, 102-4 enter (as indicated by respective vectors 110, 112) or exit (not shown) paging group 106-2 controlled by paging controller 104-1. Aperiodic triggers also may occur when mobile stations 102-1-4 currently in idle mode exit idle mode and enter active mode. Periodic triggers occur when paging controller 104-1 determines that it needs to recalculate sets S1, S2, S3, . . . , SN to provision a sufficient amount of time to transmit a backbone message to base station 108-4, and for base station 108-4 to schedule a MOB-PAG-ADV on a downlink. Base station 108-4 transmits a DREG-CMD to mobile station 102-1 with the values of PAGING_CYCLE, PAGING_OFFSET, and mobile station PAGING_LISTENING_INTERVAL that are calculated and transmitted by paging controller 104-1 to base station 108-4. The embodiments are not limited in this context.

Technique for Constructing a MOB-PAG-ADV Message

A third technique is now described for constructing a MOB-PAG-ADV message. Accordingly, prior to the start of future time instant Tx, associated with each set S1, S2, S3, . . . , SN, paging controller 104-1 may transmit a backbone message to all base stations 102-1-4 in a programming group 106-2 that identifies the timeslot parameters Tx, and ΔTx for a set Sx, one or more mobile station MAC addresses that belong to this set, and the reason for paging each of these mobile stations 102-1-4 (e.g., perform network entry, perform ranging to establish location, or some other reason). Transmission of the backbone message may be done sufficiently in advance of an upcoming base station 108-4 paging interval (BS_PAGING_INTERVAL) such that base station 108-4 has sufficient time to construct the MOB-PAG-ADV message and schedule it for downlink-transmission in their respective downlink schedulers. When there are no mobile stations 102-1-4 that need to be paged, this step may be skipped, and therefore, these operations may be optional.

Base station 108-4 constructs a MOB-PAG-ADV message for transmission in the next BS_PAGING_INTERVAL based on information received in the backbone message from paging controller 104-1 and schedules the MOB-PAG-ADV message for transmission on downlink. Mobile stations 102-1-4 receive the transmitted MOB-PAG-ADV message within their mobile station PAGING_LISTENING_INTERVALS and respond appropriately in accordance with the content of the MOB-PAG-ADV broadcast message.

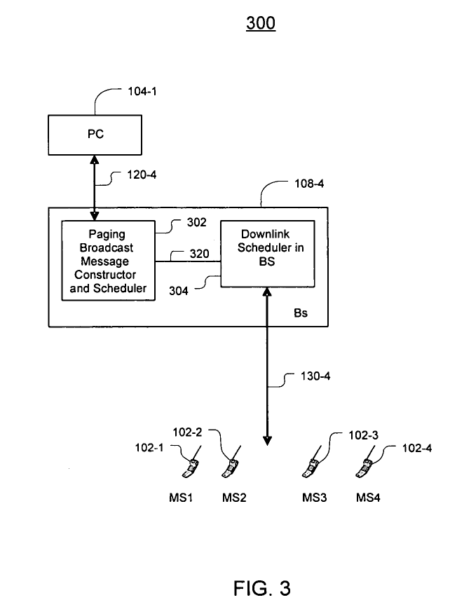

FIG. 3 illustrates one embodiment of a scheduling system. Scheduling system 300 is to schedule a single MOB-PAG-ADV broadcast message destined for a set of mobile stations (e.g., 102-1-4) located in a paging group (e.g., 106-2). In one embodiment, system 300 comprises paging controller 104-1, mobile station 108-4, and idle mode mobile stations 102-1-4, for example. In one embodiment, base station 108-4 comprises paging broadcast message constructor and scheduler 302 and downlink scheduler 304. Network backbone messages 120-4 are exchanged between paging controller 104-1 and base station 108-4. A single MOB-PAG-ADV paging message 130-4 is transmitted from base station 108-4 to mobile stations 102-1-4. In general operation of system 300, single MOB-PAG-ADV paging message 130-4 comprises information to wake up mobile stations 102-1-4 because there are incoming packets destined for each mobile station 120-1-4 at or approximately the same time as calculated by paging controller 104-1.

In one embodiment, the operation of system 300 may be described in more detail as follows. Paging controller 104-1 calculates that mobile stations 102-1-4 each have incoming packets destined for them at or approximately at the same time. Paging controller 104-1 transmits network backbone message 120-4 to base station 108-4. Paging broadcast message constructor and scheduler 302 receives network backbone message from paging controller 104-1 and constructs a MOB-PAG-ADV paging message based on information received from paging controller 104-1. As previously discussed such information may comprise PAGING_CYCLE, PAGING_OFFSET, and mobile station PAGING_LISTENING_INTERVAL, for example. MOB-PAG-ADV paging message 320 is provided to downlink scheduler 304. A single MOB-PAG-ADV paging message 130-4 is broadcast to all mobile stations 102-1-4 in paging group 106-2 of base station 108-4. The embodiments are not limited in this context.

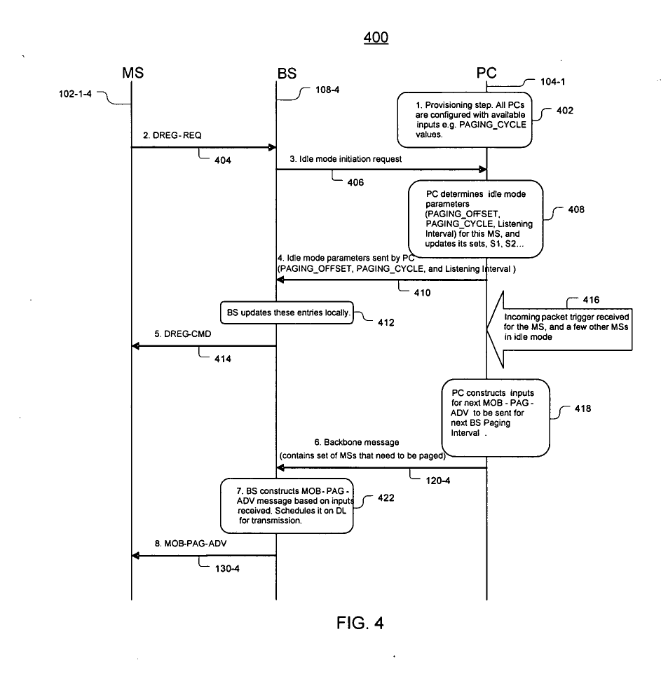

FIG. 4 illustrates one embodiment of a flow diagram. Flow diagram 400 illustrates one embodiment of a technique to manage paging operations of idle mode mobile stations in accordance with embodiments 100, 200, 300. At network provisioning time 402 all paging controllers 104-1-2 are configured with available inputs, e.g., PAGING_CYCLE values. At least one of mobile stations 102-1 transmits DREG-REQ message 404 to base station 108-4. Base station 108-4 transmits idle mode initiation request 406 to paging controller 104-1. Accordingly, paging controller 104-1 determines or computes 408 idle mode parameters (e.g., PAGING_OFFSET, PAGING_CYCLE, LISTENING_INTERVAL) for mobile station 102-1 and updates its sets S1, S2, S3, . . . SN. Paging controller 104-1 then transmits idle mode parameters 410 PAGING_OFFSET, PAGING_CYCLE, and LISTENING_INTERVAL. Base station 108-4 updates 412 these entries locally and transmits DREG-CMD 414 to mobile station 102-1. Meantime, an incoming packet trigger 416 is received by paging controller for mobile station 102-1, and some of the other mobile stations 102-2-4 in idle mode. Paging controller 104-1 then constructs 418 inputs for the next MOB-PAG-ADV message to be transmitted during the next base station paging interval. Paging controller 104-1 then transmits network backbone message 120-4 that contains a set of mobile stations 102-1-4 that need to be paged. Base station 108-4 constructs 422 a MOB-PAG-ADV paging message based on inputs received from paging controller 104-1. Base station 108-4 then schedules the transmission of the MOB-PAG-ADV paging message on the downlink. Base station 108-4 then transmits single MOB-PAG-ADV paging message 130-4 to all idle mode base stations 102-1-4. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising a paging controller to compute idle mode parameters associated with a first mobile station of at least one set of mobile stations located in a first paging group, said at least one set of mobile stations comprising said first mobile station and at least a second mobile station, and said paging controller to synchronize an upcoming mobile station paging listening interval for said at least one set of mobile stations.

2. The apparatus of claim 1, wherein said at least one set of mobile stations is characterized by timeslot parameters T and ΔT, wherein T is a time instant marking the start of a paging interval for said at least one set of mobile stations, and wherein ΔT is the duration of said upcoming mobile station paging listening interval for said at least one set of mobile stations.

3. The apparatus of claim 1, wherein said paging controller is to compute said idle mode parameters associated with multiple mobile stations located in said first paging group.

4. The apparatus of claim 1, wherein said paging controller is to dynamically compute said at least one set of mobile stations maintained in said paging controller prior to said upcoming mobile station paging listening interval for said at least one set of mobile stations.

5. The apparatus of claim 4, wherein said paging controller is to compute said idle mode parameters associated with said at least one set of mobile stations maintained in said paging controller based on a trigger.

6. The apparatus of claim 5, wherein said trigger is aperiodic, wherein said aperiodic trigger is generated when an idle mode mobile station enters or exits said first paging group; or when an idle mode mobile station exits idle mode and enter active mode; or when a packet is received for an idle mode mobile station.

7. The apparatus of claim 5, wherein said trigger is periodic, wherein said period trigger is computed by said paging controller to provision sufficient time to transmit a backbone message to a base station and to schedule a downlink to said at least one set of mobile stations.

8. The apparatus of claim 1, wherein said paging controller is to construct inputs for a paging message to be transmitted to a base station, said paging message comprising information to identify said at least one set of mobile stations to be paged at said synchronized upcoming mobile station paging listening interval.

9. The apparatus of claim 9, wherein said information comprising said timeslot parameters T and ΔT and multiple mobile station media access control addresses associated with each of said mobile stations in said at least one set of mobile stations.

10. An apparatus comprising a processor to receive a first message from a paging controller, said first message comprising identification information to identify at least one set of mobile stations located in a paging group and an upcoming mobile station paging listening interval, wherein said upcoming mobile station paging listening interval is synchronized to said at least one set of mobile stations.

11. The apparatus of claim 10, wherein said processor is to schedule transmission of a second message on downlink to said set of mobile stations located in said paging group.

12. The apparatus of claim 11, wherein said processor is to transmit said second message within said synchronized paging listening interval that is common to a listening interval of each mobile station within said set of mobile stations.

13. The apparatus of claim 10, wherein said processor is to transmit said second message when each one of said mobile stations in said set of mobile stations are scheduled to receive incoming packets.

14. An apparatus comprising:
a first mobile station comprising a processor to receive a message from a base station within a synchronized mobile station paging listening interval associated with a first set of mobile stations located in a paging group, said first set of mobile stations comprising said first mobile station, and said message comprising information associated with a paging listening interval of said first mobile station.

15. The apparatus of claim 15, wherein said first paging listening interval of said first mobile station is synchronized with a paging listening interval of a second mobile station within said first set of mobile stations located in said paging group.

16. A system, comprising:
an antenna; and
a paging controller to compute idle mode parameters associated with a first mobile station of at least one set of mobile stations located in a first paging group, said at least one set of mobile stations comprising said first mobile station and least a second mobile station, and said paging controller to synchronize an upcoming mobile station paging listening interval for said at least one set of mobile stations.

17. The system of claim 16, wherein said at least one set of mobile stations is characterized by timeslot parameters T and ΔT, wherein T is a time instant marking the start of a paging interval for said at least one set of mobile stations, and wherein ΔT is the duration of said upcoming mobile station paging listening interval for said at least one set of mobile stations.

18. The system of claim 16, wherein said paging controller is to compute idle mode parameters associated with multiple mobile stations located in said first paging group among multiple sets of mobile stations.

19. The system of claim 16, wherein said paging controller is to dynamically compute said at least one set of mobile stations maintained in said paging controller prior to said upcoming mobile station paging listening interval for said at least one set of mobile stations.

20. The apparatus of claim 16, wherein said paging controller is to construct inputs for a paging message to be transmitted to a base station, said paging message comprising information to identify said least one set of mobile stations to be paged at said synchronized upcoming mobile station paging listening interval.

21. A method comprising:
determining idle mode parameters associated with a first mobile station located in a paging group;
computing at least a first set of mobile stations comprising said first mobile station and at least a second mobile station based on said idle mode parameters; and
constructing a message to be transmitted to said set of mobile stations, said message comprising information to identify said at least one set of mobile stations to be paged at an upcoming mobile station paging listening interval, wherein said upcoming mobile station paging listening interval is synchronized between said first and second mobile station.

22. The method of claim 21, comprising:
transmitting said first message to a base station; and
constructing a second message by said base station base don information received from said first message.

23. The method of claim 22, comprising:
scheduling said second message for transmission on downlink to said first set of mobile stations.
